(19) United States
(12) Patent Application Publication
(10) Pub. No.: US 2007/0149758 A1
(43) Pub. Date: Jun. 28, 2007

(54) Aromatic polyamic acid and polyimide

(75) Inventors: Hongyuan Wang, Chiba (JP); Noriko Chikaraishi, Chiba (JP); Hironobu Kawasato, Chiba (JP)

Correspondence Address: BIRCH STEWART KOLASCH & BIRCH, PO BOX 747, FALLS CHURCH, VA, 22040-0747, US

(73) Assignee: NIPPON STEEL CHEMICAL CO., LTD., Tokyo (JP)

(21) Appl. No.: 10/584,189

(22) PCT Filed: Dec. 6, 2004
(86) PCT No.: PCT/JP04/18150

§ 371 Date: Jun. 23, 2006

(30) Foreign Application Priority Data
Dec. 26, 2003 (JP) 2003-434723

(51) Int. Cl. C08G 69/08

(52) U.S. Cl. 528/310

(57) ABSTRACT

The present invention relates to an aromatic polyimide which has excellent heat resistance and excellent thermal dimensional stability, and which realizes low hygroscopic property, and an aromatic polyamic acid as a precursor for the aromatic polyimide. Provided are an aromatic polyamic acid including a structural unit represented by the following general formula (1), and an aromatic polyimide obtained by imidating the aromatic polyamic acid. The aromatic polyamic acid or the aromatic polyimide can be a copolymerization-type aromatic polyamic acid or aromatic polyimide having another structural unit: 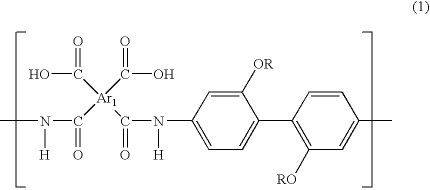
where, Ar₁ represents a tetravalent organic group produced from a tetracarboxylic acid having one or more aromatic rings, and R represents a hydrocarbon having 2 to 6 carbon atoms.

### TECHNICAL FIELD

The present invention relates to a novel aromatic polyamic acid and a novel aromatic polyimide obtained by dehydration ring closure of the aromatic polyamic acid. More specifically, the present invention relates to a novel aromatic polyamic acid obtained by introducing a monomer unit derived from a diamine having a substituent such as an ethoxy group, a propoxy group, or a phenoxy group into a molecule and a novel aromatic polyimide obtained by dehydration ring closure of the aromatic polyamic acid.

### BACKGROUND ART

A polyimide resin has been finding use in a wide variety of applications including materials for electrical and electronic equipment, in particular, electrical insulating materials each requiring heat resistance because the resin is generally extremely excellent in heat resistance, chemical resistance, electrical characteristics, and mechanical characteristics. In particular, recent progresses in improvements in function and performance of electronic equipment and a reduction in size of the electronic equipment strongly demand a polyimide resin capable of coping with the reductions in size and weight of an electronic part.

A conventional polyimide is known to have a significantly large coefficient of moisture absorption though it is superior to any other organic polymer in the heat resistance and electrical insulating property. Therefore, the conventional polyimide has been responsible for problems such as: blistering occurring upon immersion of a flexible printed wiring board in a solder bath; and the connection failure of electronic equipment due to changes in dimensions of the polyimide after moisture absorption.

Examples of the prior documents related to the present invention include the following.

Patent Document 1: JP-A-02-225522

Patent Document 2: JP-A-2001-11177

Patent Document 3: JP-A-05-271410

In view of the above-mentioned circumstances, in recent years, there has been a growing demand for a polyimide resin having very low hygroscopic property and excellent dimensional stability after moisture absorption, so various investigations into the resin have been conducted. For example, Patent Document 1 and Patent Document 2 propose a polyimide into which a fluorine-based resin is introduced so that its hydrophobicity is improved to express the low hygroscopic property. However, the polyimide involves disadvantages such as a high production cost and poor adhesiveness to a metal material. Even in other cases of attempting the reduction of hygroscopic property, as shown in Patent Document 3 or the like, no measure suffices to realize the reduction of the hygroscopic property, while maintaining good properties possessed by a polyimide, such as high heat resistance and a low coefficient of thermal expansion.

It should be noted that a polyimide has a structure in which tetracarboxylic dianhydride components and diamine components are alternately bound to each other. Patent Document 2 and Patent Document 3 exemplify polyimides each using diaminobiphenyl or a diaminobiphenyl analogue obtained by substituting diaminobiphenyl by a methoxy group as a diamine. However, the documents do not show specific examples of the polyimides, so what properties those polyimides have cannot be predicted.

### DISCLOSURE OF THE INVENTION

### Problems to be Solved by the Invention

In view of the foregoing, an object of the present invention is to provide an aromatic polyimide which has solved the above-described conventional problems, has excellent heat resistance and excellent thermal dimensional stability, and which realizes low hygroscopic property, and an aromatic polyamic acid as a precursor for the aromatic polyimide.

### MEANS FOR SOLVING THE PROBLEMS

That is, the present invention provides an aromatic polyamic acid characterized by including a structural unit represented by the following general formula (1). The present invention provides also an aromatic polyamic acid including: the structural unit represented by the general formula (1); and a structural unit represented by the following general formula (2), in which: the abundance of the structural unit represented by the general formula (1) is in the range of 10 to 90 mol %; and the abundance of the structural unit represented by the general formula (2) is in the range of 0 to 90 mol %: 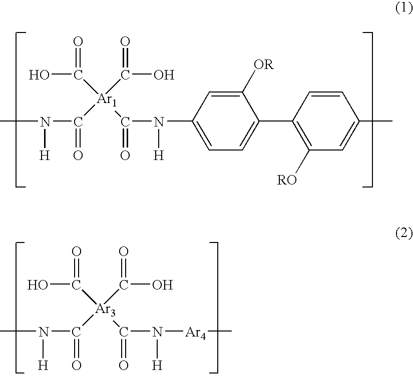
where, Ar₁ and Ar₃ each represent a tetravalent organic group having one or more aromatic rings, R represents a hydrocarbon group having 2 to 6 carbon atoms, and Ar₄ represents a divalent organic group having one or more aromatic rings.

In addition, the present invention provides an aromatic polyimide characterized by including a structural unit represented by the following general formula (3). The present invention also provides an aromatic polyimide including: the structural unit represented by the general formula (3); and a structural unit represented by the following general formula (4), in which: the abundance of the structural unit represented by the general formula (3) is in the range of 10 to 90 mol %; and the abundance of the structural unit represented by the general formula (4) is in the range of 0 to 90 mol %: 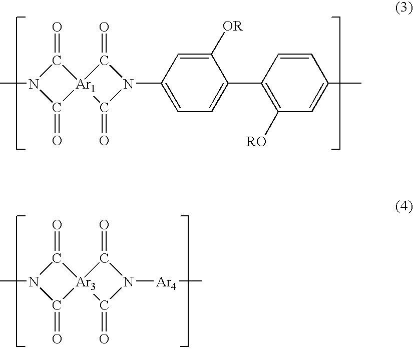
where, Ar₁ and Ar₃ each represent a tetravalent organic group having one or more aromatic rings, R represents a hydrocarbon group having 2 to 6 carbon atoms, and Ar₄ represents a divalent organic group having one or more aromatic rings.

Ar₄ in each of the structural units represented by the general formula (2) and the general formula (4) is never a group represented by the following formula (A): 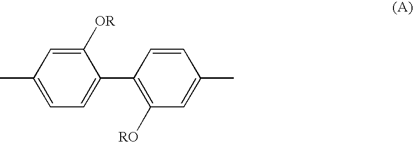
where, R represents a hydrocarbon group having 2 to 6 carbon atoms.

A polyamic acid having a structural unit represented by the general formula (1) or structural units represented by the general formulae (1) and (2) (which may hereinafter be referred to as “the Polyamic Acid”) can be said to be a precursor for a polyimide having a structural unit represented by the general formula (3) or structural units represented by the general formulae (3) and (4) (which may hereinafter be referred to as “the Polyimide”) because the Polyimide can be obtained by curing the Polyamic Acid for imidation.

In the structural units represented by the general formulae (1) to (4), Ar₁ and Ar₃ each represent a tetravalent organic group having one or more aromatic rings, so each of them can be said to be an aromatic tetracarboxylic acid residue produced from an aromatic tetracarboxylic acid or from a dianhydride or the like of the acid. Therefore, the explanation of the aromatic tetracarboxylic acid to be used leads to the understanding of Ar₁ or the like. Preferable examples of Ar₁ and Ar₃ will be described below by using an aromatic tetracarboxylic dianhydride because the aromatic tetracarboxylic dianhydride is often used for synthesizing the Polyimide or the Polyamic Acid having the above structural units in ordinary cases.

The aromatic tetracarboxylic dianhydride is not particularly limited, and any known one can be used therefor. Specific examples of the aromatic tetracarboxylic dianhydride include pyromellitic dianhydride, 3,3′,4,4′-benzophenonetetracarboxylic dianhydride, 2,2′,3,3′-benzophenonetetracarboxylic dianhydride, 2,2,3′,4′-benzophenonetetracarboxylic dianhydride, naphthalene-2,3,6,7-tetracarboxylic dianhydride, naphthalene-1,2,5,6-tetracarboxylic dianhydride, naphthalene-1,2,4,5-tetracarboxylic dianhydride, naphthalene-1,4,5,8-tetracarboxylic dianhydride, naphthalene-1,2,6,7-tetracarboxylic dianhydride, 4,8-dimethyl-1,2,3,5,6,7-hexahydronaphthalene-1,2,5,6-tetracarboxylic dianhydride, 4,8-dimethyl-1,2,3,5,6,7-hexahydronaphthalene-2,3,6,7-tetracarboxylic dianhydride, 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, 1,4,5,8-tetrachloronaphthalene-2,3,6,7-tetracarboxylic dianhydride, 3,3′,4,4′-biphenyltetracarboxylic dianhydride, 2,2′,3,3′-biphenyltetracarboxylic dianhydride, 2,3,3′,4′-biphenyltetracarboxylic dianhydride, 3,3″,4,4″-p-terphenyltetracarboxylic dianhydride, 2,2″,3,3″-p-terphenyltetracarboxylic dianhydride, 2,3,3″,4″-p-terphenyltetracarboxylic dianhydride, 2,2-bis(2,3-dicarboxyphenyl)-propane dianhydride, 2,2-bis(3,4-dicarboxyphenyl)-propane dianhydride, bis(2,3-dicarboxyphenyl)ether dianhydride, bis(2,3-dicarboxyphenyl)methane dianhydride, bis(3,4-dicarboxyphenyl)methane dianhydride, bis(2,3-dicarboxyphenyl)sulfone dianhydride, bis(3,4-dicarboxyphenyl)sulfone dianhydride, 1,1-bis(2,3-dicarboxyphenyl)ethane dianhydride, 1,1-bis(3,4-dicarboxyphenyl)ethane dianhydride, perylene-2,3,8,9-tetracarboxylic dianhydride, perylene-3,4,9,10-tetracarboxylic dianhydride, a perylene-4,5,10,11-tetracarboxylic dianhydride, perylene-5,6,11,12-tetracarboxylic dianhydride, phenantherene-1,2,7,8-tetracarboxylic dianhydride, phenantherene-1,2,6,7-tetracarboxylic dianhydride, phenantherene-1,2,9,10-tetracarboxylic dianhydride, cyclopentane-1,2,3,4-tetracarboxylic dianhydride, a pyrazine-2,3,5,6-tetracarboxylic dianhydride, pyrrolidine-2,3,4,5-tetracarboxylic dianhydride, thiophene-2,3,4,5-tetracarboxylic dianhydride, and 4,4′-oxydiphthalic dianhydride. Further, those can be used alone or in combination of two or more kinds thereof.

Of those, an aromatic tetracarboxylic dianhydride selected from the group consisting of pyromellitic dianhydride (PMDA), 3,3′,4,4′-biphenyltetracarboxylic dianhydride (BPDA), naphthalene-2,3,6,7-tetracarboxylic dianhydride (NTCDA), naphthalene-1,4,5,8-tetracarboxylic dianhydride, 3,3″,4,4″-p-terphenyltetracarboxylic dianhydride, 4,4′-oxydiphthalic dianhydride, 3,3′4,4′-benzophenonetetracarboxylic dianhydride, and a bis(2,3-dicarboxyphenyl)sulfone dianhydride is preferably used, and one selected from the group consisting of a PMDA, an NTCDA, and a BPDA is more preferably used. Each of those aromatic tetracarboxylic dianhydrides can also be used together with other aromatic tetracarboxylic dianhydride. However, 50 mol % or more, preferably 70 mol % or more of the total amount of the aromatic tetracarboxylic dianhydride may be used.

To be specific, a suitable tetracarboxylic dianhydride is preferably selected in such a manner that properties required for intended purposes, such as the coefficient of thermal expansion, thermal decomposition temperature, and glass transition temperature of a polyimide obtained by the polymerization and heating of the dianhydride, are expressed. It is preferable to use 60 mol % or more of each of PMDA and NTCDA in consideration of a balance among various properties such as heat resistance, low hygroscopic property, and a dimensional change. When the usage of BPDA is large, the coefficient of thermal expansion of a polyimide increases, and the heat resistance (glass transition temperature) of the polyimide reduces. Accordingly, the content of BPDA is preferably in the range of 20 to 50 mol % of the total number of moles of the acid anhydride.

A diamine used for synthesizing the Polyamic Acid or the Polyimide having a structural unit represented by the general formula (1) or (3) is an aromatic diamine represented by the following general formula (5) (which may hereinafter be referred to as “the Aromatic Diamine”).

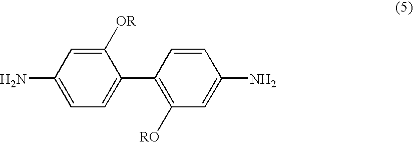

In the formula, R has the same meaning as that of R in the general formula (1) or (3), and represents a hydrocarbon group having 2 to 6 carbon atoms, preferably an alkyl group having 2 to 4 carbon atoms or an aryl group having 6 carbon atoms, or more preferably an ethyl group, an n-propyl group, or a phenyl group.

The Polyamic Acid or the Polyimide can be advantageously obtained by reacting an aromatic tetracarboxylic dianhydride and a diamine containing 10 mol % or more of the Aromatic Diamine.

The Aromatic Diamine represented by the general formula (5) can be synthesized through the following steps. For example, the Aromatic Diamine in which R represents a hydrocarbon having 3 to 6 carbon atoms can be obtained through: a step (Step-I) of synthesizing an alkoxynitrobenzene or an allyloxynitrobenzene by etherifying the corresponding nitrophenol; and a step (Step-II) of producing a target aromatic diamine by subjecting the corresponding alkoxynitrobenzene or allyloxynitrobenzene to benzidine rearrangement via a hydrazo body.

The reaction for synthesizing an alkoxynitrobenzene in Step-I has been known through documents such as T. Sala, M. V. Sargent, J. Chem. Soc., Perkin I, p 2593—(1979) and R. B. Bates, K. D. Janda, J. Org. Chem., vol. 47, p 4374—(1982). Various kinds of alkoxynitrobenzenes can be obtained in extremely high yield within a reaction time of about 15 hours. Nitrophenetole serving as a raw material for the Aromatic Diamine in which R represents an ethyl group is commercially available, so it can be used for producing such the Aromatic Diamine, or such the aromatic diamine can be synthesized from nitrophenol by the above-mentioned method. In addition, the synthesis of an allyloxynitrobenzene in high yield is achieved by utilizing a known reaction described in, for example, J. S. Wallace, Loon-S. Tan, F. E. Arnold Polymer, vol. 31, p 2412—(1990) or JP-A-61-194055. A known reaction described in R. B. Carlin, J. Am. Chem. Soc., vol. 67, p 928—(1945) may be used in the reaction of Step-II to obtain a benzidine skeleton without production of a semidine- or diphenyline-type isomer.

The purity of each of those aromatic diamine components each having a benzidine skeleton can be additionally increased through fractionation by means of column chromatography followed by recrystallization by means of a mixed solvent of methanol and water or a mixed solvent of hexane and ethyl acetate.

In the present invention, 90 mol % or less of any other diamine except the aromatic diamine represented by the general formula (5) can be used in combination with the aromatic diamine. The combined use can result in a copolymerization-type polyamic acid or polyimide having a structural unit represented by the general formula (2) or the general formula (4).

The Polyamic Acid or the Polyimide may be composed only of a structural unit represented by the general formula (1) or (3), or may include structural units having such structural unit and a structural unit represented by the general formula (2) or the general formula (4). The Polyamic Acid or the Polyimide may include any other structural unit except those described above in some cases, but the content of the other structural unit is desirably 20 mol % or less, or preferably 10 mol % or less.

In a similar manner, Ar₁ or Ar₃ may be identical to or different from each other. Ar₁ or Ar₃ may be composed of multiple kinds of tetravalent organic groups.

The Polyamic Acid or the Polyimide is preferably composed only of a structural unit represented by the general formula (1) or (3), or is preferably composed of such structural unit and a structural unit represented by the general formula (2) or the general formula (4).

The content of the structural unit represented by the general formula (1) or (3) in the Polyamic Acid or the Polyimide is desirably 10 to 100 mol %, preferably 50 to 100 mol %, more preferably 70 to 100 mol %, or still more preferably 90 to 100 mol %. When the Polyamic Acid or the Polyimide is of a copolymerization-type having a structural unit represented by the general formula (2) or the general formula (4), the content of the structural unit represented by the general formula (2) or the general formula (4) in the polyamic acid or the polyimide is desirably 1 to 90 mol %, preferably 1 to 50 mol %, more preferably 5 to 30 mol %, or still more preferably 10 to 20 mol %. A value for a ratio m/(m+n), where m represents the molar abundance of the structural unit represented by the general formula (1) or (3) and n represents the molar abundance of the structural unit represented by the general formula (2) or the general formula (4), is 0.1 or more, preferably 0.5 to 1, or more preferably 0.8 to 1.

An aromatic diamine that provides a structural unit represented by the general formula (2) or (4), is not particularly limited except for the aromatic diamine that provides a structure unit represented by the general formula (1) or (3). Examples of the aromatic diamine include 4,6-dimethyl-m-phenylenediamine, 2,5-dimethyl-p-phenylenediamine, 2,4-diaminomesitylene, 4,4′-methylenedi-o-toluidine, 4,4′-methylenedi-2,6-xylidine, 4,4′-methylene-2,6-diethylaniline, 2,4-toluenediamine, m-phenylenediamine, p-phenylenediamine, 4,4′-diaminodiphenyl propane, 3,3′-diaminodiphenyl propane, 4,4′-diaminodiphenyl ethane, 3,3′-diaminodiphenyl ethane, 4,4′-diaminodiphenyl methane, 3,3′-diaminodiphenyl methane, 2,2-bis[4-(4-aminophenoxy)phenyl]propane, 4,4′-diaminodiphenyl sulfide, 3,3′-diaminodiphenyl sulfide, 4,4′-diaminodiphenyl sulfone, 3,3′-diaminodiphenyl sulfone, 4,4′-diaminodiphenyl ether, 3,3′-diaminodiphenyl ether, 1,3-bis(3-aminophenoxy)benzene, 1,3-bis(4-aminophenoxy)benzene, 1,4-bis(4-aminophenoxy)benzene, benzidine, 3,3′-diaminobiphenyl, 3,3′-dimethyl-4,4′-diaminobiphenyl, 3,3′-dimethoxybenzidine, 4,4′-diamino-p-terphenyl, 3,3′-diamino-p-terphenyl, bis(p-aminocyclohexyl)methane, bis(p-β-amino-t-butylphenyl)ether, bis(p-β-methyl-δ-aminopentyl)benzene, p-bis(2-methyl-4-aminopentyl)benzene, p-bis(1,1-dimethyl-5-aminopentyl)benzene, 1,5-diaminonaphthalene, 2,6-diaminonaphthalene, 2,4-bis(β-amino-t-butyl)toluene, 2,4-diaminotoluene, m-xylene-2,5-diamine, p-xylene-2,5-diamine, m-xylylenediamine, p-xylylenediamine, 2,6-diaminopyridine, 2,5-diaminopyridine, 2,5-diamino-1,3,4-oxadiazole, and piperazine.

Of those, 2,2′-dimethyl-4,4′-diaminobiphenyl (m-TB), 4,4′-diaminodiphenyl ether (DAPE), 1,3-bis(4-aminophenoxy)benzene (TPE-R), or the like is preferably used. When such the diamine is used, the rate to be used is preferably in a range of from 3 to 50 mol % of the total diamine.

The aromatic polyamic acid can be produced by means of a known method involving using the aromatic diamine component and the aromatic tetracarboxylic dianhydride component described above at a molar ratio of 0.9 to 1.1 to polymerize them in an organic polar solvent. That is, the Aromatic Polyamic Acid can be produced by: dissolving an aromatic diamine into an aprotic amide-based solvent such as N,N-dimethylacetamide or N-methyl-2-pyrrolidone in a stream of nitrogen; adding an aromatic tetracarboxylic dianhydride to the solution; and subjecting the resultant to a reaction at room temperature for about 3 to 4 hours. At this time, a molecular terminal may be sealed with an aromatic monoamine or an aromatic dicarboxylic anhydride.

The Polyimide can be produced by imidating the Polyamic Acid thus produced by means of a thermal imidation method or a chemical imidation method. Thermal imidation involves: applying the Polyamic Acid to an arbitrary base material such as a copper foil with an applicator; preliminarily drying the resultant at a temperature of 150° C. or lower for 2 to 60 minutes; removing the solvent; and subjecting the resultant to a heat treatment generally at a temperature of about 130 to 360° C. for about 2 to 30 minutes for imidation. Chemical imidation involves: adding a dehydrator and a catalyst to the Polyamic Acid; and chemically dehydrating the resultant at 30 to 60° C. A representative example of the dehydrator is acetic anhydride, and a representative example of the catalyst is pyridine.

The degree of polymerization of each of the Polyamic Acid and the Polyimide is desirably in the range of 1 to 10, or preferably 3 to 7 in terms of reduced viscosity of a polyamic acid solution. A reduced viscosity (η sp/C) can be calculated from (t/t0−1)/C through measurement with an Ubbelohde viscometer in N,N-dimethylacetamide at 30° C. and a concentration of 0.5 g/dL. In addition, the molecular weight of the polyamic acid of the present invention can be determined by means of a GPC method. The number average molecular weight (in terms of polystyrene) of the Polyamic Acid is preferably in the range of 15,000 to 250,000, and the weight average molecular weight (in terms of polystyrene) of the Polyamic Acid is preferably in the range of 30,000 to 800,000. The molecular weight of the Polyimide is also in the same range as that of the molecular weight of a precursor for the Polyimide.

The Polyimide can be blended with any one of various fillers and additives so as to be used as a polyimide composition to the extent that an object of the present invention is not impaired.

### BRIEF DESCRIPTION OF THE DRAWINGS

FIG. 1 An IR spectrum of a polyimide A.

FIG. 2 An IR spectrum of a polyimide E.

FIG. 3 An IR spectrum of a polyimide J.

### BEST MODE FOR CARRYING OUT THE INVENTION

Hereinafter, the contents of the present invention will be specifically described on the basis of Examples. However, the present invention is not limited to the scope of these Examples.

The abbreviations used in Examples etc. are shown below.

PMDA: pyromellitic dianhydride

BPDA: 3,3′,4,4′-biphenyltetracarboxylic dianhydride

m-EOB: 2,2′-diethoxybenzidiene

M-NPOB: 2,2′-di-n-propyloxybenzidine

m-PHOB: 2,2′-diphenyloxybenzidine

m-MOB: 2,2′-dimethoxybenzidine

m-TB: 2,2′-dimethylbenzidine

DAPE: 4,4′-diaminodiphenyl ether

TPE-R: 1,3-bis(4-aminophenoxy)benzene

NTCDA: naphthalene-2, 3,6,7-tetracarboxylic dianhydride

DMF: N,N-dimethylformamide

DMAC: N,N-dimethylacetamide

Methods and conditions for measuring various physical properties in the examples will be shown below.

[Glass Transition Temperature (Tg) and Storage Elastic Modulus (E′)]

The dynamic viscoelasticity of a polyimide film (10 mm×22.6 mm) obtained in each example was measured while the temperature of the film was increased from 20° C. to 500° C. at 5° C./min in DMA. Then, a glass transition temperature (local maximum of tan δ), and a storage elastic modulus (E′) at each of 23° C. and 100° C. were determined.

[Measurement of Coefficient of Linear Expansion (CTE)]

A polyimide film having a size measuring 3 mm×15 mm was subjected to a tensile test in the temperature range of 30° C. to 260° C. at a constant rate of temperature increase while a load of 5.0 g was applied by using an apparatus for thermomechanical analysis (TMA). A coefficient of linear expansion was measured from the elongation amount of the polyimide film with respect to a temperature.

[Measurement of Thermal Decomposition Temperature (Td5%)]

A change in weight of a polyimide film having a weight of 10 to 20 mg when the temperature of the film was increased from 30° C. to 550° C. at a constant rate by using a thermogravimetric (TG) analyzer was measured, and the temperature at which the weight of the film reduced by 5% (Td5%) was determined.

[Measurement of Coefficient of Moisture Absorption]

Each of three polyimide films each measuring 4 cm×20 cm was dried at 120° C. for 2 hours. After that, each of the films was left standing in a thermo-hygrostat at 23° C. and 50% RH for 24 hours or longer. A coefficient of moisture absorption was determined from the following expression on the basis of a weight change before and after the standing.
Coefficient of moisture absorption(%)=[(weight after moisture absorption−weight after drying)/weight after drying]×100

[Measurement of Coefficient of Humidity Expansion (CHE)]

An etching resist layer was provided onto a copper foil of a polyimide/copper foil laminate measuring 35 cm×35 cm. The layer was formed into a pattern in which 12 points each having a diameter of 1 mm were arranged at an interval of 10 cm on the four sides of a square 30 cm on a side. The copper foil-exposing portion of an etching resist opening was etched, whereby a polyimide film for CHE measurement having 12 copper foil-remaining points was obtained. The film was dried at 120° C. for 2 hours, and then its temperature was cooled to 23° C. After that, the film was left standing in a thermo-hygrostat (23° C.) at a humidity of each of 30% RH, 50% RH, and 70% RH for 24 hours. A dimensional change between copper foil points due to a humidity change was measured, whereby a coefficient of humidity expansion was determined. In Table 1, a CHE0-50% was calculated from the measurement of a dimensional change between the time after drying and a humidity of 50% RH, and a CHE30-70% was calculated from the measurement of a dimensional change among the humidities of 30% RH, 50% RH, and 70% RH.

### EXAMPLES

First, a synthesis example of a diamine component to be used in the production of a polyimide according to the present invention will be described.

### Synthesis Example 1

Step-1 Synthesis of Azo Compound

66 g of 3-nitrophenetole, 394 ml of ethyl alcohol, 197 ml of a 30-wt % aqueous solution of caustic soda, and 77 g of a zinc powder were sequentially added to a three-necked flask having a stirrer in it, and the whole was subjected to a reaction at a boiling point temperature for 3 hours. After ethyl alcohol had been nearly completely distilled off, the zinc powder was removed. After the resultant had been extracted with toluene, the solvent was distilled off, and 50 g of a brown solid were collected.

Step-2 Synthesis of Hydrazo Compound

45 g of the reaction product obtained in Step-1, 358 ml of ethyl alcohol, and 36 ml of acetic acid were added to a three-necked flask having a stirrer in it, and the temperature of the mixture was heated to a boiling point temperature. After that, 52 g of a zinc powder were added to the resultant. After the observation of the immediate color fading of an orange color in the system, the reaction content was poured into a 0.1-wt % aqueous solution of soda sulfite at 70° C. The zinc powder was removed through filtration, and the filtrate was left for 2 hours. After that, the precipitated white precipitate was collected through filtration, and was dried under reduced pressure, whereby 45 g of a white-to-pale yellow solid were obtained.

Step-3 Synthesis of Rearrangement Reaction Product

43 g of the reaction product obtained in Step-2 and 420 ml of diethyl ether were added to a three-necked flask having a stirrer in it, and the temperature of the mixture was cooled to 0° C. After that, 105 ml of cold hydrochloric acid composed of 37% concentrated hydrochloric acid and distilled water (at a volume ratio of 50:50) were added dropwise to the mixture. After the resultant had been subjected to a reaction in an ice bath for 2 hours, 110 ml of a 20-wt % aqueous solution of caustic soda were slowly dropped to the resultant in such a manner that the pH of the resultant would be 11 or more (that is, the resultant would be alkaline), and then the reaction was stopped. The resultant was extracted with toluene, and the solvent was distilled off. After that, the resultant was purified by means of column chromatography, and was then recrystallized by using a mixed solvent of methanol and water, whereby 16 g of a tan needle-like crystal were obtained. The yield of the product thus finally obtained was 32% throughout the three stages, and the product had a melting point of 115 to 117° C.

NMR Measurements (Solvent CDCl₃)

6.3 to 7.0 ppm Aromatic ring hydrogen

3.9 ppm Methylene group hydrogen in OCH2CH3 group

3.6 ppm Hydrogen in NH2 group

1.3 ppm Methyl group hydrogen in OCH2CH3 group

The above results confirmed that the product was 2,2′-diethoxybenzidine (m-EOB) as a target.

### Synthesis Example 2

In a nitrogen atmosphere, 44 g of 3-nitrophenol were added to a three-necked flask having a stirrer in it, and were dissolved into 317 ml of DMF. 53 g of potassium carbonate and 37 ml of 1-iodopropane were sequentially added to the solution, and the whole was subjected to a reaction at room temperature for 13 hours. 200 ml of a saturated aqueous solution of ammonium chloride were added to the resultant to stop the reaction. The resultant was extracted with 300 ml of a mixed solvent of hexane and ethyl acetate (hexane:ethyl acetate=3:1), and the solvent was distilled off. After that, the resultant was purified by means of column chromatography, whereby 57 g of 3-nitro-n-propyloxybenzene as a light yellow liquid substance were obtained.

A reaction similar to that of Synthesis Example 1 was hereinafter performed by using 57 g of 3-nitro-n-propoxybenzene obtained above, whereby 9.4 g of a tan needle-like crystal as a final target product were obtained. The product had a melting point of 122 to 125° C.

NMR Results (Solvent CDCl₃)

6.3 to 7.0 ppm Aromatic ring hydrogen

3.8 ppm Hydrogen in CH2 adjacent to 0 in —OCH2CH2CH3

3.6 ppm Hydrogen in —NH2

1.6 ppm Hydrogen in middle CH2 in —OCH2CH2CH3

0.9 ppm Hydrogen in terminal CH3 in —OCH2CH2CH3

The above results confirmed that the product was 2,2′-di-n-propoxybenzidine (m-NPOB) as a target.

### Synthesis Example 3

In a nitrogen atmosphere, 73 g of 1,3-dinitrobenzene were added to a three-necked flask having a stirrer in it, and were dissolved into 433 ml of DMF. 61 g of phenol and 120 g of potassium carbonate were sequentially added to the solution, and the temperature of the mixture was increased from room temperature to 150° C. over 2 hours. After that, the resultant was subjected to a reaction for 16 hours while its temperature was kept at 150° C. After the temperature of the reaction liquid had been cooled to room temperature, insoluble potassium nitrate was removed through filtration, the remainder was extracted with toluene, and the solvent was distilled off. After that, the resultant was purified by means of column chromatography, whereby 84 g of a white solid substance were obtained.

A reaction similar to that of Synthesis Example 1 was hereinafter performed by using 53 g of 3-phenoxynitrobenzene obtained above. It should be noted that a reaction in the step of synthesizing a rearrangement reaction product did not proceed under ice cooling, so THF was used as a reaction solvent, and cold hydrochloric acid was dropped before a reaction was performed at room temperature for 24 hours. As a result, 16 g of a white crystalline substance as a final target product were obtained. The yield of the product thus finally obtained was 32% throughout the four stages, and the product had a melting point of 180 to 181° C.

NMR Results (Solvent CDCl₃)

6.2 to 7.3 ppm Aromatic ring hydrogen (8H)

3.6 ppm Hydrogen in —NH2

The above results confirmed that the product was 2,2′-diphenoxybenzidine (m-NPOB) as a target.

### Examples 1 to 14

To synthesize each of polyamic acids A to N, a diamine shown in Table 1 was dissolved into 43 g of DMAc as a solvent while being stirred in a 100-ml separable flask in a stream of nitrogen. Next, a tetracarboxylic dianhydride shown in Table 1 was added. After that, the solution was subjected to a polymerization reaction while being continuously stirred at room temperature for 3 hours, whereby a yellow-to-tan viscous solution of each of the polyamic acids A to N each serving as a polyimide precursor was obtained. The reduced viscosity (η sp/C) of each polyamic acid solution was in the range of 3 to 6. Table 1 shows the weight average molecular weight (Mw) of each solution as well.

Each of the polyimide precursor solutions A to N was applied to a copper foil with an applicator in such a manner that the film thickness after drying would be about 15 μm, and was then dried at 50 to 130° C. for 2 to 60 minutes. After that, the resultant was subjected to a stepwise heat treatment at each of 130° C., 160° C., 200° C., 230° C., 280° C., 320° C., and 360° C. for 2 to 30 minutes, whereby a polyimide layer was formed on the copper foil.

The copper foil was removed through etching by using an aqueous solution of ferric chloride, whereby each of film-like polyimides A to N was produced. Then, the glass transition temperature (Tg), storage elastic modulus (E′), coefficient of thermal expansion (CTE), temperature at which a weight reduced by 5% (Td5%), coefficient of moisture absorption, and coefficient of humidity expansion (CHE) of each polyimide were determined. The polyimides A to N mean that they were obtained from the polyamic acids A to N. Table 2 shows the results. Each of the polyimides obtained in the examples showed a low elastic modulus, a low coefficient of moisture absorption, and a low coefficient of humidity expansion while maintaining heat resistance.

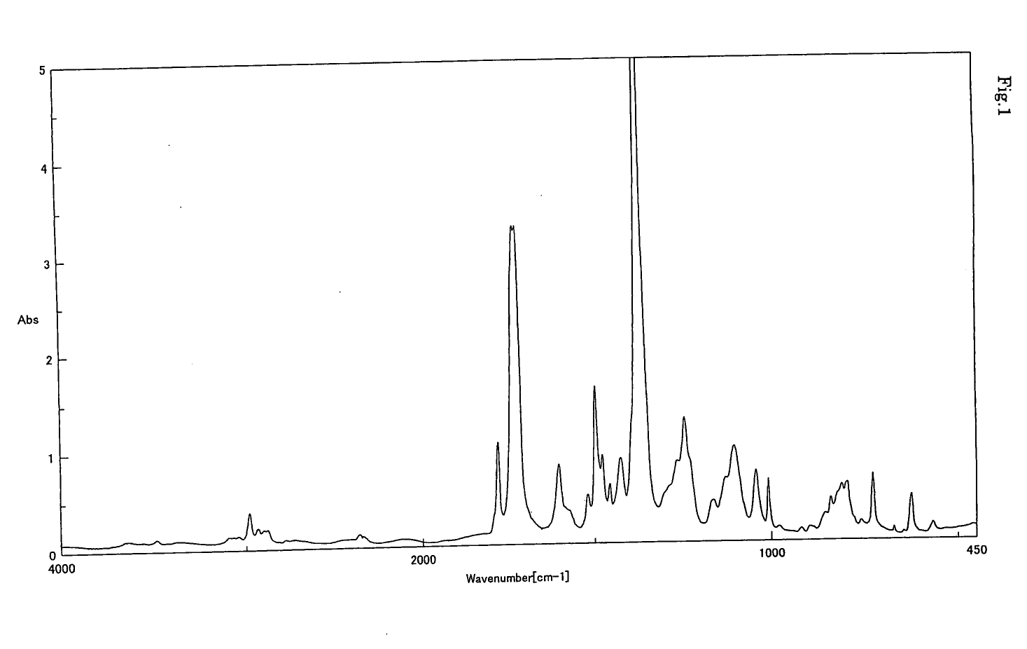

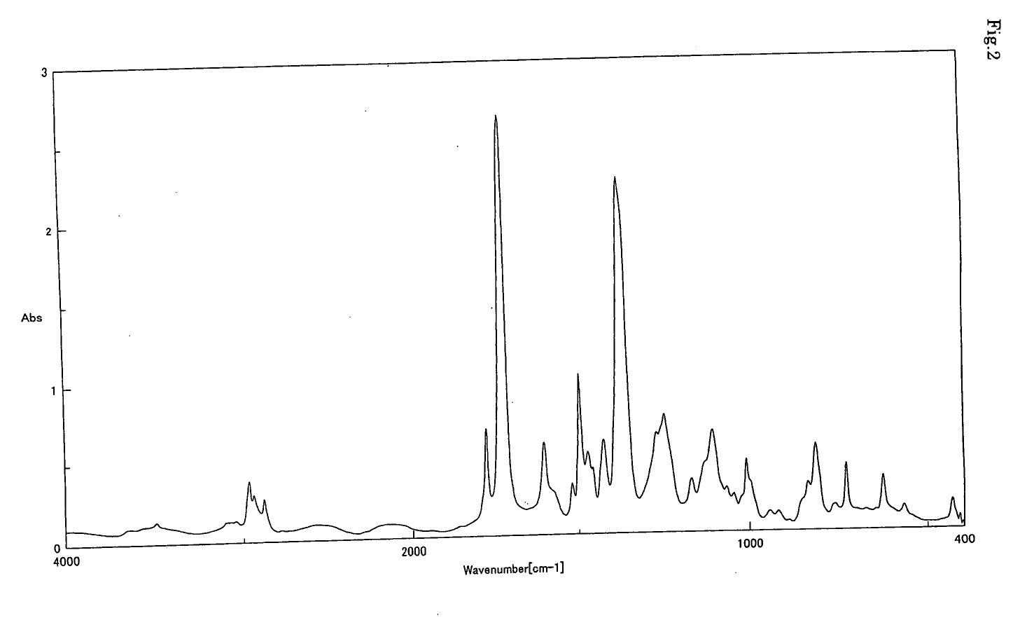

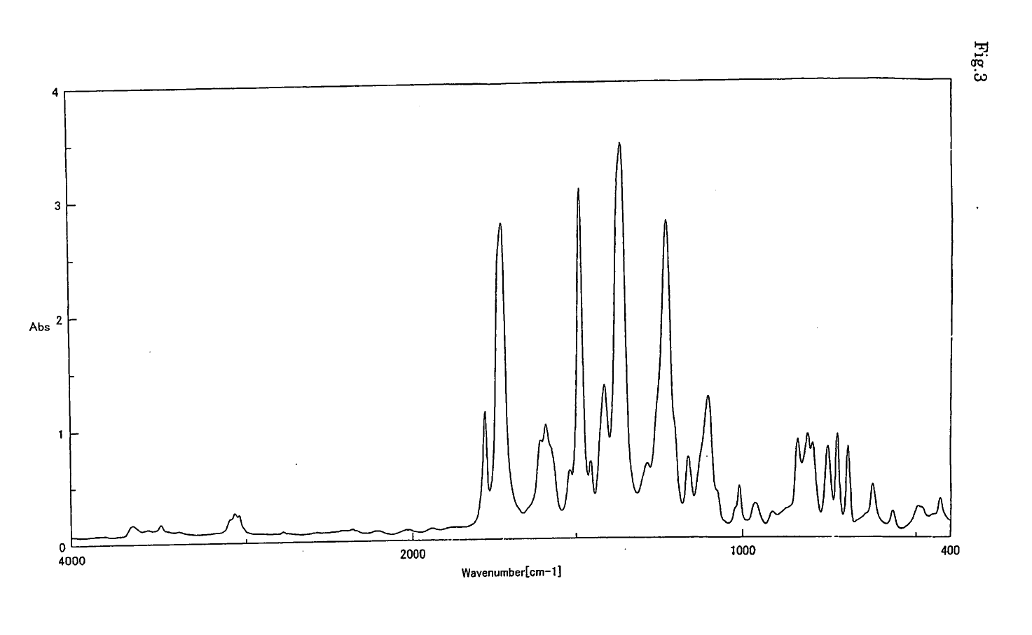

FIGS. 1 to 3 show the structural analyses of representative polyimide films by means of IR.

### Example 15

0.2548 g of pyridine and 0.0395 g of acetic anhydride were added to 100 g of a solution of the polyamic acid J, and a polyimide film was obtained through chemical imidation. The physical properties of the film were measured. As a result, the film had a CTE of 16 ppm/° C., and other physical properties of the film were comparable to those of a polyimide obtained through thermal imidation shown in Table 1.

### Comparative Examples 1 to 3

Each of polyamic acids O to Q was synthesized by blending raw materials shown in Table 1, and then a polyimide film was produced in the same manner as in Example 1. The film was evaluated for each property in the same manner as in each example. Table 2 shows the results. The coefficient of moisture absorption and coefficient of humidity expansion of the polyimide film O could not be measured because the film was brittle.

TABLE 1

| | Example | | | | | | | | |
|---|---|---|---|---|---|---|---|---|---|
| Raw material (g) | 1 | 2 | 3 | 4 | 5 | 6 | 7 | 8 | 9 |
| m-MOB | — | — | — | — | — | — | — | — | — |
| m-EOB | 3.62 | 3.54 | 3.25 | 1.96 | — | — | — | — | — |
| m-NPOB | — | — | — | — | 3.78 | 3.70 | 3.41 | 2.67 | — |
| m-PHOB | — | — | — | — | — | — | — | — | 4.41 |
| m-TB | — | — | — | — | — | — | — | — | — |
| DAPE | — | — | — | 1.45 | — | — | — | — | — |
| TPE-R | — | — | — | — | — | — | — | 1.12 | — |
| PMDA | 2.90 | 2.27 | — | 3.11 | 2.74 | 2.15 | — | 2.74 | — |
| BPDA | — | 0.71 | 3.27 | — | — | 0.68 | 3.11 | — | — |
| NTCDA | — | — | — | — | — | — | — | — | 3.16 |
| Polyamic acid | A | B | C | D | E | F | G | H | I |
| Molecular weight | 150 | 474 | 58 | 84 | 112 | 58 | 160 | 188 | 262 |
| Mw (×10³) | | | | | | | | | |

| | |
|---|---|
| | Comparative |
| Example | Example |

| Raw material (g) | 10 | 11 | 12 | 13 | 14 | 1 | 2 | 3 |
|---|---|---|---|---|---|---|---|---|
| m-MOB | — | — | — | — | — | 3.44 | 2.96 | 3.33 |
| m-EOB | — | — | — | — | — | — | — | — |
| m-NPOB | — | — | — | — | — | — | — | — |
| m-PHOB | 4.10 | 3.99 | 3.62 | 3.46 | 2.36 | — | — | — |
| m-TB | — | — | — | 0.50 | 1.36 | — | — | — |
| DAPE | — | — | — | — | — | — | — | — |
| TPE-R | — | — | — | — | — | — | — | — |
| PMDA | 2.43 | 1.89 | — | 2.56 | 2.80 | 3.08 | — | 2.38 |
| BPDA | — | 0.64 | 2.90 | — | — | — | 3.56 | 0.80 |
| NTCDA | — | — | — | — | — | — | — | — |
| Polyamic acid | J | K | L | M | N | O | P | Q |
| Molecular weight | 218 | 208 | 172 | 152 | 229 | 263 | 225 | 259 |
| Mw (×10³) | | | | | | | | |

TABLE 2

| | | Example | | | | | | | | |
|---|---|---|---|---|---|---|---|---|---|---|
| | | 1 | 2 | 3 | 4 | 5 | 6 | 7 | 8 | 9 |
| Polyimide | | A | B | C | D | E | F | G | H | I |
| Tg (° C.) | | 378 | 378 | 270 | 376 | 378 | 365 | 276 | 355 | 382 |
| E′ [23° C.] (GPa) | | 9.51 | 6.80 | 5.40 | 4.65 | 4.90 | 4.49 | 3.80 | 3.20 | 6.21 |
| E′ [100° C.] (GPa) | | 8.08 | 5.36 | 4.48 | 3.66 | 3.91 | 3.95 | 2.82 | 2.90 | 5.11 |
| CTE (ppm/° C.) | | −7.7 | 14 | 58 | 22 | −11 | 24 | 66 | 54 | 21 |
| Td5% (° C.) | | 431 | 434 | 443 | 465 | 426 | 439 | 421 | 446 | 545 |
| Coefficient of | | 1.31 | 1.27 | 0.88 | 1.37 | 0.64 | 0.83 | 0.76 | 0.55 | 0.58 |
| moisture | | | | | | | | | | |
| absorption (wt %) | | | | | | | | | | |
| CHE 0-50% | TD | 0.3 | 5.4 | 9.4 | 9.7 | −2.2 | −1.0 | −7.9 | 2.8 | −3.3 |
| (ppm/% RH) | MD | 0.3 | 5.5 | 8.8 | 9.9 | −0.5 | 0 | −7.2 | 1.9 | −3.2 |
| CHE 30-70% | TD | 7.7 | 11.0 | — | — | 2.4 | — | — | — | 5.2 |
| (ppm/% RH) | MD | 8.6 | 11.8 | — | — | 2.3 | — | — | — | 5.0 |

| | |
|---|---|
| | Comparative |
| Example | Example |

| | | 10 | 11 | 12 | 13 | 14 | 1 | 2 | 3 |
|---|---|---|---|---|---|---|---|---|---|
| Polyimide | | J | K | L | M | N | O | P | Q |
| Tg (° C.) | | 394 | 391 | 254 | 372 | 374 | 403 | 430 | 365 |
| E′ [23° C.] (GPa) | | 5.17 | 4.95 | 3.35 | 8.93 | 8.74 | 15.40 | 10.20 | 10.30 |
| E′ [100° C.] (GPa) | | 4.50 | 4.35 | 2.76 | 8.43 | 8.10 | 14.10 | 9.12 | 9.26 |
| CTE (ppm/° C.) | | 17 | 51 | 55 | 19 | 12 | −6.9 | 8.7 | −2.0 |
| Td5% (° C.) | | 539 | 543 | 550 | 502 | 490 | 457 | 477 | 481 |
| Coefficient of | | 0.55 | 0.68 | 0.62 | 0.75 | 1.03 | — | 1.35 | 1.76 |
| moisture | | | | | | | | | |
| absorption (wt %) | | | | | | | | | |
| CHE 0-50% | TD | −2.1 | −4.1 | −4.4 | 1.4 | 3.1 | — | 9.7 | 9.8 |
| (ppm/% RH) | MD | −1.6 | −4.2 | −3.9 | 0.8 | 2.7 | — | 7.6 | 9.7 |
| CHE 30-70% | TD | 3.6 | 6.3 | 5.3 | 8.2 | 7.8 | — | 9.4 | 11.4 |
| (ppm/% RH) | MD | 4.4 | 6.2 | 4.6 | 7.9 | 7.3 | — | 9.9 | 10.2 |

### INDUSTRIAL APPLICABILITY

A polyimide having excellent heat resistance, excellent thermal dimensional stability, and low hygroscopic property can be obtained by subjecting the polyamic acid of the present invention to dehydration and ring closure. In addition, the polyimide of the present invention is resistant to heat at 400° C. or higher, and can show an elastic modulus at each of 23° C. and 100° C. of 2 to 10 GPa and a coefficient of moisture absorption of 1.5% or less. In particular, a polyimide obtained through polymerization using PMDA as an aromatic tetracarboxylic dianhydride can show a coefficient of thermal expansion of 25 ppm/° C. or less, a coefficient of moisture absorption of 1.0 wt % or less, and a coefficient of humidity expansion at 0 to 50% RH of 10 ppm % RH or less, or advantageously 5 ppm % RH or less. Therefore, the polyimide can be excellent in heat resistance, dimensional stability, and elastic modulus, and can show low hygroscopic property. The polyimide of the present invention can be used in various fields including an electrical and electronic field owing to those properties. The polyimide is particularly useful as an insulating material for a wiring substrate.

1. An aromatic polyamic acid comprising a structural unit represented by the following general formula (1) 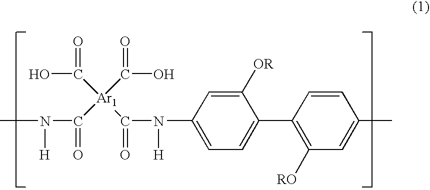
where Ar₁ represents a tetravalent organic group having one or more aromatic rings and R represents a hydrocarbon group having 2 to 6 carbon atoms.

2. An aromatic polyamic acid according to claim 1, comprising:
the structural unit represented by the general formula (1); and
a structural unit represented by the following general formula (2): 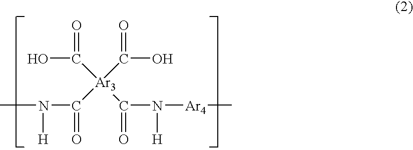
where Ar₃ represents a tetravalent organic group having one or more aromatic rings and Ar₄ represents a divalent organic group having one or more aromatic rings, the structural unit represented by the general formula (2) being never identical to the structural unit represented by the general formula (1),
wherein:
an abundance of the structural unit represented by the general formula (1) is in a range of from 10 to 90 mol %; and
an abundance of the structural unit represented by the general formula (2) is in a range of from 0 to 90 mol %.

3. An aromatic polyimide comprising a structural unit represented by the following general formula (3): 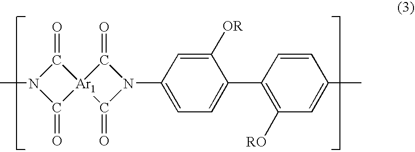
where Ar₁ represents a tetravalent organic group having one or more aromatic rings and R represents a hydrocarbon group having 2 to 6 carbon atoms.

4. An aromatic polyimide according to claim 3, comprising:
the structural unit represented by the general formula (3); and
a structural unit represented by the following general formula (4): 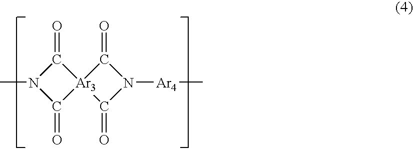
where Ar₃ represents a tetravalent organic group having one or more aromatic rings and Ar₄ represents a divalent organic group having one or more aromatic rings, the structural unit represented by the general formula (4) being never identical to the structural unit represented by the general formula (3),
wherein:
an abundance of the structural unit represented by the general formula (3) is in a range of from 10 to 90 mol %; and
an abundance of the structural unit represented by the general formula (4) is in a range of from 0 to 90 mol %.

5. An aromatic polyimide according to claim 3 or 4, wherein at least part of each of Ar₁ and Ar₃ in the general formula (3) and the general formula (4) comprises at least one kind of an aromatic tetracarboxylic acid residue selected from the group consisting of pyromellitic dianhydride, 3,3′,4,4′-biphenyltetracarboxylic dianhydride, naphthalene-2,3,6,7-tetracarboxylic dianhydride, naphthalene-1,4,5,8-tetracarboxylic dianhydride, 3,3″,4,4″-p-terphenyltetracarboxylic dianhydride, 4,4′-oxydiphthalic dianhydride, 3,3′4,4′-benzophenonetetracarboxylic dianhydride, and bis(2,3-dicarboxyphenyl)sulfonic dianhydride.

6. An aromatic polyimide according to claim 3 or 4, which has an elastic modulus at 23° C. of 2 to 10 GPa, a coefficient of moisture absorption of 1.0 wt % or less, a coefficient of humidity expansion at 0 to 50% RH of 10 ppm/% RH or less, and a coefficient of thermal expansion of 25 ppm/° C. or less.

7. A method of producing the aromatic polyimide according to claim 3 or 4, comprising imidating the aromatic polyamic acid according to claim 1 or 2.
